(19) United States
(12) Patent Application Publication
(10) Pub. No.: US 2006/0163362 A1
(43) Pub. Date: Jul. 27, 2006

(54) Collectable stored value cards and debit cards

(76) Inventor: Enrique Pallares, Wellington, FL (US)

Correspondence Address: Steven L. Schmid, 1257 Donald Street, Jacksonville, FL, 32205, US

(21) Appl. No.: 11/044,990

(22) Filed: Jan. 27, 2005

(51) Int. Cl. G06K 19/00; G06K 5/00

(52) U.S. Cl. 235/487; 235/380

(57) ABSTRACT

Disclosed is a collectable stored value card and a collectable debit card that has both a monetary value for what is stored on the card and an ephemeral value that is placed on the card by a collector. The collector may also place a monetary value of the ephemeral value of the card. The collectable card may be decorative in nature or may have some other indicia that would attach an ephemeral value to the card.

### FIELD OF THE INVENTION

The present invention generally relates to debit cards and stored value cards and in particular, to debit cards and stored value cards having an intrinsic value, as well as ephemeral value placed thereon by the collectors.

### BACKGROUND

Debit cards are used to engage in cashless transactions. In a debit card scenario rather than funds being accessed by a credit card company, a debit card accesses funds that are directly in a consumer's bank account. Thus, if money is present in a consumer's bank account, such money may be spent. If insufficient funds are present in the account, the amount of a purchase cannot be spent.

A further cashless system is the “stored value card.” The stored-value card comprises a credit card-like device. The stored-value card allows an electronic representation of a consumer's money to be stored on the card. That money is deducted from a consumer's bank account and represented in electronic form on the stored-value card.

Additionally, debit cards and stored value cards may be configured to be non-loadable, meaning that a user is not allowed to load the card with further funds. These cards are typically linked to a user's bank account or are purchased from a vendor and come in fixed value increments, for example, $10, $20, and $50. A $10 card provides the customer with $10 of purchasing power utilizing an existing debit card system. The cards are batch activated by the card provider in a limited number of predetermined values. A customer purchases one of these pre-activated cards by paying a fee. The cards typically include a predetermined identification code. Gift cards are an example of non-loadable cards that enable a customer to present recipients gifts with a convenient and easy to use payment mechanism. However, once the recipient has used the card, its usefulness is exhausted, and is generally thrown away.

Thus, the only value to a customer of a stored value card or a debit card is the money loaded on the card. The cards are purchased and used for the money the card enables a used to access. Once a card's value has been used up or when the consumer no longer wishes to load the card with further value the card essentially becomes worthless and is discarded.

Thus, what is needed is an apparatus and method that would add value to a debit/stored value card once the card's monetary value has expired.

### SUMMARY

The present invention generally provides for a collectable stored value card and a collectable debit card that has both a monetary value for the currency stored on the card and an ephemeral value that is placed on the card by a collector separate from the currency value stored on the card. The collector may also place a monetary value of the ephemeral value of the card. The collectable card may be decorative in nature or may have further indicia that would attach an ephemeral value to the card.

In greater detail, the card is a collectable stored value/debit card comprising a card that has imprinted on it indicia. The indicia can be selected from such images as graphic or photographic images, but other indicia are contemplated. Example further indicia include embossings or holograms. Furthermore, the card has an ephemeral value placed upon the card by a collector who may value the card for various reasons based upon such indicia to impart the ephemeral value.

The card can also include account information associated with the stored value/debit card printed or embossed on the card. The card may be collectable in a series. In a further embodiment the card may be associated with a gaming system. The gaming system can include a collection of cards having values or points associated with each distinct individual card.

The stored value/debit card may have an initial monetary value that can be reloaded by a cardholder or another. The card may be used for a plurality of transactions, wherein each successive one of the plurality of transactions decreases a remaining value on the card. The card can be issued in a limited number and have an intrinsic value separate from a stored monetary value of the card.

A further embodiment includes a collectable stored value/debit card comprising a card having indicia. The indicia imprinted on the card include images selected from the group consisting essentially of graphic images, photographic images and combinations thereof. Furthermore, the card has an ephemeral value placed upon the card by a collector who is an individual who places a monetary value on the card due to the card having the ephemeral value derived in part from the indicia.

An additional embodiment includes a method of providing a collectable stored value/debit card. The method includes providing a card and imprinting indicia on to the card. The indicia includes images selected from the group consisting essentially of graphic images, photographic images, embossed images, attached images and combinations thereof. The method further includes placing an ephemeral value placed upon the card by a collector who is an individual.

The invention accordingly comprises the features of the construction, combination of elements and arrangement of components, which will be exemplified in the embodiments hereinafter set forth and in the accompanying drawings, and the scope of the invention will be indicated in the claims.

### DRAWINGS

In the Drawings:

FIG. 1 depicts one embodiment of the collectable stored value/debit card of the present invention wherein the indicia may be a graphic image that is imprinted on the surface of the card;

FIG. 2 illustrates a further embodiment of the collectable stored value/debit card of the present invention wherein the indicia may be an embossed image embossed on the surface of the card; and

FIG. 3 depicts an additional embodiment of the collectable stored value/debit card of the present invention wherein the indicia may be an affixed image on the surface of the card.

### DETAILED DESCRIPTION

Disclosed is a collectable stored value card and a collectable debit card that has both a monetary value for currency values stored on the card and an ephemeral value that is placed on the card by a collector. The ephemeral value is derived from indicia added to the card. The indicia may be in the form of imprinted images, embossed images, or affixed images to the card. Furthermore, the images can be graphic or photographic. Additionally, incorporated herein by reference in its entirety is U.S. patent application Ser. No. ______ titled A SYSTEM FOR OPERATING A PREPAID RELOADABLE DEBIT CARD HAVING ANCILLARY SERVICES filed Dec. 17, 2004.

The term “ephemeral value” refers to the value placed on the card that is separate from the monetary value that the card represents. The term “ephemeral” means herein a value that can be lasting, but such a value is tied the indicia placed on the card. Thus, such a value may have a short-lived value depending upon the demand and desire for the card. As with most collectables, values tend to fluctuate depending upon the market place desire for the item. As fads come and go, the ephemeral value of the card will fluctuate, but the stored monetary value of the card only fluctuates with the use and loading of the card. Thus, the term “ephemeral value” can be defined in an embodiment of the present invention to mean that value which is placed on the card that is apart from the stored monetary value on the card. The “ephemeral value” may have a monetary value that is attributed to the card by the collector that is separate from the stored monetary value.

The term “collectable” refers to the desire of a collector to have and collect the card. The term “collector” is defined as a person or entity that desires to have or hold the card for the card's “ephemeral value” as defined herein.

The terms “stored value card” and “debit card” are used interchangeably within the present application to refer to cards that are either “loaded” or “loadable” with a monetary amount. Furthermore, the term “card” can refer to a credit or debit card of any kind, including but not limited to: an Affinity Credit Card; a Gifi Card; a Prepaid Debit Card; a Stored Value Card; a Corporate Credit or Debit Card; a Bank Card; a Funded Card. The cards may be used as any credit card or ATM card.

The terms “loaded” or “loadable” refer to a process whereby a cardholder authorizes a transfer of funds into an account associated with a card. Once loaded, the card is authorized for use in payment of future purchases, up to the amount of the loaded value. When the cardholder presents the card to a merchant as payment for a purchase, funds to cover the amount of the purchase are transferred from the account to the merchant's account. The amount of funds transferred is accordingly debited from the account associated with the stored-value card. Optionally, the stored-value card may also be reloaded with value in order to replenish the monetary funds for available for card transactions. Example existing ATM/credit card infrastructures include VISA.®, MASTER CARD.® and DISCOVER.® credit or debits cards.

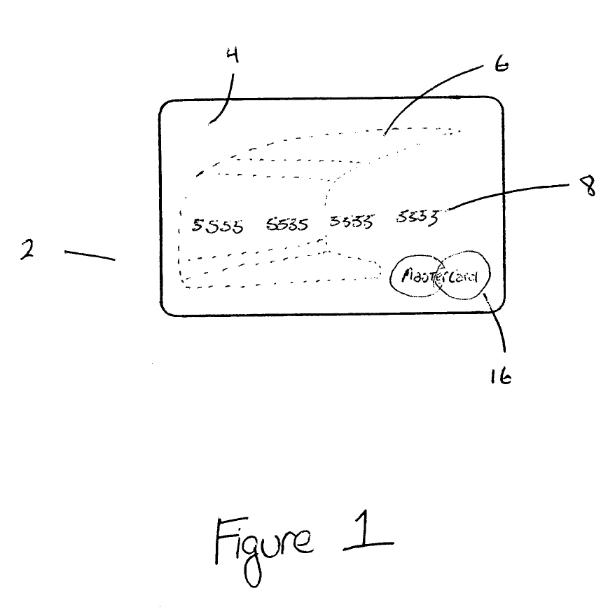

Referring now in greater detail to the drawings in which like numerals indicate like parts throughout the several views, FIGS. 1-3 depict the collectable debit/stored value card in various embodiments of the present invention.

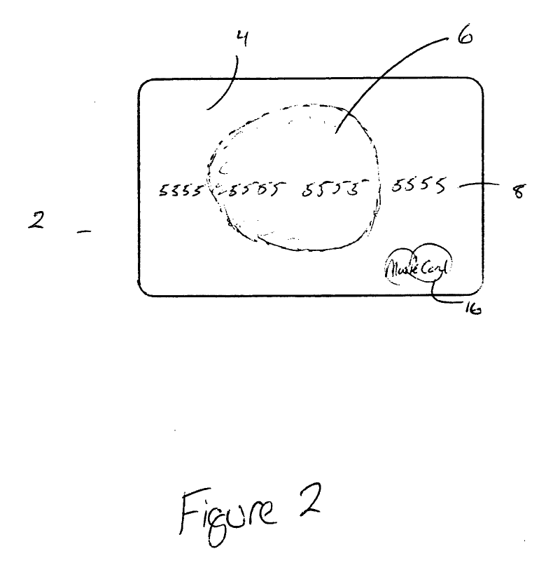

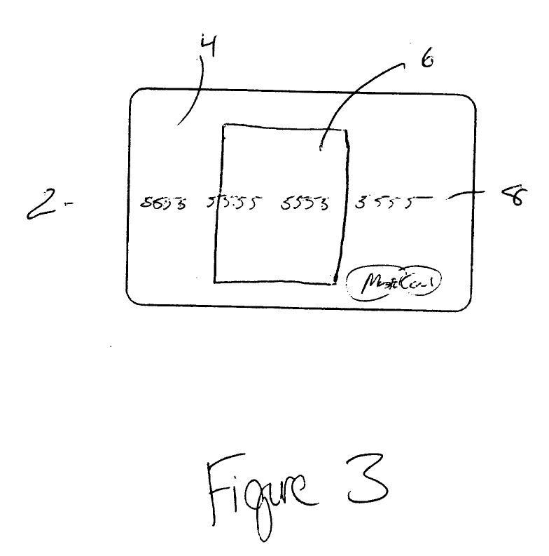

As illustrated in FIG. 1, the collectable card 2 includes a card 4 that functions as a stored value/debit card 2. The stored value card 2 may be branded with a bankcard logo 16. The indicia 6 can be graphic images as illustrated in FIG. 1. By way of example and not by limitation the graphic image 6 can be graphic images of sports team logos, abstract art or other images that may hold an ephemeral value to a collector. A further example of a graphic image may include a cartoon character. Additionally, the image 6 may be a photograph. As illustrated in FIG. 2, the card 4 may also be embossed with an image 6. And as illustrated in FIG. 3, the card 4 may have an indicia 6 applied to the card 4. The applied indicia 6 can be in the form of a sticker like patch the may be either attached to the card by lamination or by an adhesive. Furthermore, the sticker like patch can be a hologram. The card 4 can also include account information 8 associated with the stored value/debit card 2 printed or embossed on the card.

The card 2 may be collectable in a series. The collectable series by way of example and not by limitation can include a series of related figures, collectable characters and various scenic depictions. Furthermore, the card 2 in a further embodiment may be associated with a gaming system. The gaming system can include a collection of cards having values or points associated with each distinct individual card.

In greater detail, the indicia 6 can be present in or on either one or both surfaces of the card 4. For a multilayer card 4, such as a laminated paper card, indicia may be present on the paper base with a plastic coating thereover. Alternately, indicia 6 may be present within or on the plastic coating.

Indicia 6 can be any visual marking on the card 4. Indicia 6 can be text or graphics on items. Examples of suitable text includes jokes, riddles, fortunes, encouraging sayings, trivia questions or other mind games, wisdom, motivational sayings, poems, famous quotes, and the like. Examples of graphics include depictions of sports figures, sports team logos, corporate logos and other organization logos, movie stars, music stars, political figures, cartoons, animals, states, shapes, colors, and the like. Holograms can be used to provide a special or spectacular image. The indicia present on the card 4 may be distantly related so that the card 4 has a theme associated therewith.

Indicia 6 may be present within the card 4, that is, indicia 6 are present within the card 4 rather than present on the surface thereof. Examples include having indicia on a paper base, which is then coated. In further embodiment, indicia 6 may be present as three-dimensional embossed, raised, or textured areas as shown in FIG. 3. For example, indicia may be raised above surface. In another variation, indicia may be present as apertures or other areas within the item devoid of material.

An additional embodiment includes a method of providing a collectable stored value/debit card. The method includes providing a card and imprinting indicia on to the card. The indicia include images selected from the group consisting essentially of graphic images, photographic images and combinations thereof. The method further includes placing an ephemeral value placed upon the card by a collector who is an individual.

While Applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

1. A collectable stored value/debit card comprising:
a card having indicia, wherein the card has an ephemeral value placed upon the card by a collector.

2. The collectable stored value/debit card of claim 1, wherein the indicia includes an image, the image includes photographic images and/or graphic images.

3. The collectable stored value/debit card of claim 1, wherein the indicia includes an image, the image includes an embossed image and/or an attached image.

4. The collectable stored value/debit card of claim 1, wherein the card further includes information relating to an account associated with the stored value/debit card.

5. The collectable stored value/debit card of claim 1, wherein the card is collectable in a series.

6. The collectable stored value/debit card of claim 1, wherein the card is associated with a gaming system.

7. The collectable stored value/debit card of claim 6, wherein the gaming system includes a collection of cards having values or points associated with each distinct individual card.

8. The collectable stored value/debit card of claim 1, wherein the collector is an individual who places a monetary value on the card due to the card having the ephemeral value.

9. The collectable stored value/debit card of claim 1, wherein the card has an initial monetary value.

10. The collectable stored value/debit card of claim 1, wherein the card may be used for a plurality of transactions, and wherein each successive one of the plurality of transactions decreases a remaining value on the card.

11. The collectable stored value/debit card of claim 1, wherein in the card is of a limited number.

12. The collectable stored value/debit card of claim 1, wherein the card has an intrinsic value separate from a stored monetary value of the card.

13. A collectable stored value/debit card comprising:
a card having indicia, the indicia having images selected from the group consisting essentially of graphic images, photographic images, embossed images and attached images and combinations thereof; and wherein the card has an ephemeral value placed upon the card by a collector who is an individual who places a monetary value on the card due to the card having the ephemeral value.

14. The collectable stored value/debit card of claim 13, wherein the card is associated with a gaming system.

15. The collectable stored value/debit card of claim 14, wherein the gaming system includes a collection of cards having values or points associated with each distinct individual card.

16. The collectable stored value/debit card of claim 13, wherein the card is of a limited number.

17. The collectable stored value/debit card of claim 13, wherein the card may be used for a plurality of transactions, and wherein each successive one of the plurality of transactions decreases a remaining value on the card.

18. A method of providing a collectable stored value/debit card comprising:
providing a card;
imprinting indicia on to the card, wherein the indicia includes images selected from the group consisting essentially of graphic images, photographic images, embossed images, attached images and combinations thereof; and
placing an ephemeral value placed upon the card by a collector.

19. The method of claim 18, wherein the card is issued in a limited number.

20. The method of claim 18, using the card for a plurality of transactions, and wherein each successive one of the plurality of transactions decreases a remaining value on the card.
